(19) United States
(12) Patent Application Publication
(10) Pub. No.: US 2012/0166238 A1
(43) Pub. Date: Jun. 28, 2012

(54) Requirement Generator

(75) Inventors: Soumendra Mohanty, Powai (IN); Shagufta Kohli, Mumbai (IN); Kumar Jeyaprakasam, Perambur (IN); Dayasagar Manohar, Kanagam (IN); Joe Pushparaj, Sivaganga (IN)

(73) Assignee: ACCENTURE GLOBAL SERVICES LIMITED, Dublin (IE)

(21) Appl. No.: 13/337,984

(22) Filed: Dec. 27, 2011

(30) Foreign Application Priority Data
Dec. 28, 2010 (IN) 3977/CHE/2010

(51) Int. Cl. G06Q 10/06

(52) U.S. Cl. 705/7.11

(57) ABSTRACT

A requirement generation system receives user input selecting, from among key performance indicators stored in key performance indicator data defining key performance indicators available for selection in defining a requirement for a project, one or more key performance indicators to include in a requirement for a project. The requirement generation system defines the requirement for the project based on the received user input selecting the one or more key performance indicators and determines technical requirements for the requirement for the project based on mapping data defining formula and one or more data structures used in determining a measure of the one or more selected key performance indicators. The requirement generation system generates a data model mapping document for the project based on the determined technical requirements and outputs the generated data model mapping document.

### CROSS-REFERENCE TO RELATED APPLICATION(S)

The present application claims the benefit of Indian Patent Application No. 3977/CHE/2010, filed on Dec. 28, 2010, which is incorporated herein by reference in its entirety for all purposes.

### FIELD

This disclosure relates to requirement generation for projects.

### BACKGROUND

An analyst may design a project in terms of key performance indicators that are relevant to the objectives of the project. The analyst may manually determine the key performance indicators that are relevant to the project and identify the requirements for the project based on the determined key performance indicators. Thereafter, an engineer, programmer, or other technologist may manually review the requirements for the project in terms of key performance indicators and determine technical requirements needed to implement the project.

### SUMMARY

In one aspect, a computer system includes at least one processor and at least one memory coupled to the at least one processor having stored thereon key performance indicator data defining key performance indicators available for selection in defining a requirement for a project and mapping data defining formula and one or more data structures used in determining a measure of each key performance indicator included in the key performance indicator data. The at least one memory also has stored thereon instructions which, when executed by the at least one processor, cause the at least one processor to perform operations. The operations include receiving user input selecting, from among the key performance indicators defined by the key performance indicator data, one or more key performance indicators to include in a requirement for a project and defining the requirement for the project based on the received user input selecting the one or more key performance indicators. The operations also include determining technical requirements for the requirement for the project based on the mapping data defining formula and one or more data structures used in determining a measure of the one or more selected key performance indicators. The operations further include generating a data model mapping document for the project based on the determined technical requirements and outputting the generated data model mapping document.

Implementations may include one or more of the following features. For example, the key performance indicator data may define key performance indicators available for selection in defining a business requirement for a business intelligence project. In this example, the operations may include receiving user input selecting one or more key performance indicators to include in a business requirement for a business intelligence project and defining the business requirement for the business intelligence project based on the received user input selecting the one or more key performance indicators. The operations also may include determining technical requirements for the business requirement for the business intelligence project based on the mapping data defining formula and one or more data structures used in determining a measure of the one or more selected key performance indicators. The operations further may include generating a data model mapping document for the business intelligence project based on the determined technical requirements.

In some implementations, the operations may include receiving user input selecting an industry associated with the project and identifying, from among the key performance indicators defined by the key performance indicator data, key performance indicators that are appropriate for the selected industry. In these implementations, the operations may include presenting, for selection, the identified key performance indicators that are appropriate for the selected industry and receiving user input selecting, from among the identified key performance indicators that are appropriate for the selected industry, one or more key performance indicators to include in the requirement for the project. The identified key performance indicators that are appropriate for the selected industry may include generic key performance indicators that are pre-defined as common key performance indicators for the selected industry.

In some examples, the operations may include receiving user input selecting an industry associated with the project and identifying, from among the data structures included in the mapping data, data structures that are appropriate for the selected industry. In these examples, the operations may include presenting, for selection, the identified data structures that are appropriate for the selected industry and receiving user input selecting, from among the identified data structures that are appropriate for the selected industry, one or more data structures to include in the requirement for the project. The identified data structures that are appropriate for the selected industry may include generic data structures that are pre-defined as common data structures for the selected industry.

In addition, the identified data structures that are appropriate for the selected industry may include system-specific data structures that are data structures for the selected industry included in a system on which the project is to be implemented. Further, the operations may include receiving user input selecting an industry associated with the project and identifying, from among the key performance indicators defined by the key performance indicator data, key performance indicators that are appropriate for the selected industry. The operations also may include identifying, from among the data structures included in the mapping data, data structures that are appropriate for the selected industry, presenting, for selection, the identified key performance indicators that are appropriate for the selected industry, and presenting, for selection, the identified data structures that are appropriate for the selected industry. The operations further may include receiving user input selecting, from among the identified key performance indicators that are appropriate for the selected industry, one or more key performance indicators to include in the requirement for the project and receiving user input selecting, from among the identified data structures that are appropriate for the selected industry, one or more data structures to include in the requirement for the project.

In some implementations, the operations may include receiving user input defining a user-specific key performance indicator that is different from the key performance indicators defined by the key performance indicator data and defining the requirement for the project based on the received user input selecting the one or more key performance indicators and the received user input defining the user-specific key performance indicator. The operations may include generating a reporting template for the project based on the requirement for the project and the determined technical requirements and outputting the generated reporting template.

In some examples, the operations may include generating code for determining a measure of each of the one or more selected key performance indicators using the mapping data that pre-defines the formula and the one or more data structures used in determining the measure of each of the one or more selected key performance indicators. In these examples, the operations may include enabling a user to provide input to change the generated code for determining the measure of each of the one or more selected key performance indicators and validating the generated code for determining the measure of each of the one or more selected key performance indicators. Further, in these examples, the operations may include testing the generated code for determining the measure of each of the one or more selected key performance indicators on a system on which the project is to be implemented.

In some implementations, the operations may include displaying, in a graphical user interface, a list of key performance indicators available for inclusion in a requirement for a project and receiving user input dragging, from the list of key performance indicators available for inclusion in the requirement for the project, a key performance indicator into a project definition area of the graphical user interface. In these implementations, the operations may include identifying, based on the mapping data, one or more data structures that store data needed in determining a measure for the key performance indicator dragged into the project definition area of the graphical user interface. Also, in these implementations, the operations may include displaying, in the project definition area of the graphical user interface, the identified one or more data structures in connection with the key performance indicator and defining the requirement for the project based on the key performance indicator and the identified one or more data structures.

In addition, the mapping data may include a source to target mapping table and the operations may include determining technical requirements for the requirement for the project based on the source to target mapping table. The operations also may include generating a data model for the project based on the determined technical requirements and outputting the generated data model. The operations further may include generating an extract, transform, and load design for the project based on the determined technical requirements and outputting the generated extract, transform, and load design.

In another aspect, a method includes receiving user input selecting, from among key performance indicators stored in key performance indicator data defining key performance indicators available for selection in defining a requirement for a project, one or more key performance indicators to include in a requirement for a project and defining the requirement for the project based on the received user input selecting the one or more key performance indicators. The method also includes determining technical requirements for the requirement for the project based on mapping data defining formula and one or more data structures used in determining a measure of the one or more selected key performance indicators. The method further includes generating a data model mapping document for the project based on the determined technical requirements and outputting the generated data model mapping document.

In yet another aspect, at least one computer-readable storage medium is encoded with executable instructions that, when executed by at least one processor, cause the at least one processor to perform operations. The operations include receiving user input selecting, from among key performance indicators stored in key performance indicator data defining key performance indicators available for selection in defining a requirement for a project, one or more key performance indicators to include in a requirement for a project and defining the requirement for the project based on the received user input selecting the one or more key performance indicators. The operations also include determining technical requirements for the requirement for the project based on mapping data defining formula and one or more data structures used in determining a measure of the one or more selected key performance indicators. The operations further include generating a data model mapping document for the project based on the determined technical requirements and outputting the generated data model mapping document.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIGS. 1 and 2 are diagrams of exemplary systems.

FIG. 3 is a flowchart of an exemplary process.

FIG. 4 is a diagram illustrating exemplary user interface components.

FIGS. 5A to 5C are diagrams illustrating exemplary user interfaces

FIG. 6 is a diagram illustrating an exemplary source to target mapping table.

FIG. 7 is a diagram illustrating an exemplary data model.

FIG. 8 is a diagram illustrating an exemplary extract, transform, and load design.

FIG. 9 is a diagram of an exemplary system.

Like reference numbers represent corresponding parts throughout.

### DETAILED DESCRIPTION

Techniques are disclosed for facilitating generation of requirements for a project. For instance, a business intelligence requirement generator tool may include a technical layer for generating a business requirement as well as an industry-oriented metadata layer that defines generic key performance indicators and formula relevant to the industry. The business intelligence requirement generator tool may allow a user to choose from the existing pool of key performance indicators and/or generate a new set of key performance indicators. The business intelligence requirement generator tool may use selected key performance indicators to determine and output a data model mapping document that defines a data model and/or an extract, transform, load layer of the business intelligence project.

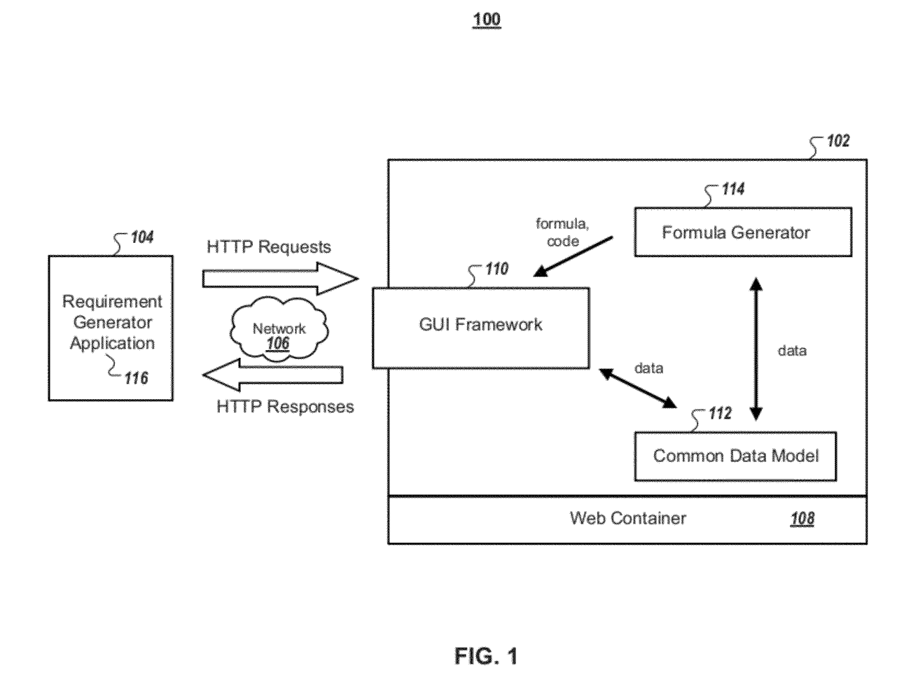

FIG. 1 illustrates an exemplary system 100 for generating a requirement for a project. The system 100 includes a requirement generator system 102 and a client device 104, connected to the requirement generator system 102 by way of a network 106. The network 106 may be a private network, such as an intranet, a public network, such as the Internet, or some combination thereof. The client device 104 may be, for example, a laptop computer, or a desktop computer, or some other type of computing device.

The requirement generator system 102 includes a web container layer 108, a graphical user interface framework 110, a common data model 112, and a formula generator 114. The web container layer 108 provides a runtime environment for the graphical user interface framework 110, the common data model 112, and the formula generator 114, including support for security, concurrency, lifecycle management, transaction, deployment, and other services, to name a few examples.

The graphical user interface framework 110 provides a graphical user interface to the client device 104. For example, a web browser application may run on the client device 104 and the graphical user interface framework 102 may provide, to the client device 104, a web page implementing a requirement generator application 116 for presentation on the client device 104. The user of the client device 104 may, using the requirement generator application 116, select industry and sub-industry (e.g., subject area) information related to a project for which to define requirements. In response to the user selection of an industry, the graphical user interface framework 110 may retrieve, from the common data model 112, a set of generic key performance indicators pre-defined as being appropriate for the selected industry and a set of data structures that correspond to the generic key performance indicators. The graphical user interface framework 110 may generate one or more selection lists to assist the user of the client device 104 in defining requirements for the project in terms of key performance indicators. For example, the graphical user interface framework 110 may generate a first selection list including the generic key performance indicators pre-defined as being appropriate for the selected industry and a second selection list including the data structures that correspond to the generic key performance indicators. In this example, the graphical user interface framework 110 may send the selection lists to the requirement generator application 116.

The user of the client device 104 may select one or more key performance indicators to include as a requirement for the project. For instance, the user of the client device 104 may drag a key performance indicator from a selection list and drop the key performance indicator onto a project definition area displayed in the requirement generator application 116. The requirement generator application 116 may determine, through communication with the graphical user interface framework 110, one or more data structures that correspond to the selected key performance indicator and display the determined one or more data structures in association with the selected key performance indicator.

In some examples, the user also may select one or more data structures, and may drop them onto the project definition area. The user selections may be received by the graphical user interface framework 110. A requirement may be defined based on the selected key performance indicator and the selected data structures. The requirement definition may be stored in the common data model 112 or another electronic storage device.

In some implementations, technical requirements may be determined for the project based on selected key performance indicators and selected data structures. In these implementations, the technical requirements may be determined based on mapping data that is stored in the common data model 112. For example, mapping data may include, for each key performance indicator, a formula definition defining a formula used in determining a measure of the key performance indicator. The formula may indicate which data is needed to determine the measure of the key performance indicator and how the data is processed to arrive at the measure of the key performance indicator. The formula generator 114 may generate code to implement the formula. The code may be sent to the client device 104 for presentation in the requirement generator application 116.

The requirement generator application 116 may include one or more controls which allow the user to edit the code, such as to tailor the code for a particular project. The requirement generator application 116 may include a control to allow the user to validate the generated code. For example, test data may be retrieved from the common data model 112 and the formula generator 114 may execute the generated code using the test data.

The formula generator 114 may also generate one or more data model mapping documents based on the determined technical requirements, and may output the generated data model mapping document. For example, a data model may be generated and may be stored in the common data model 112 or another electronic storage device. As another example, an extract, transform, and load design may be generated and may be stored in the common data model 112 or another electronic storage device.

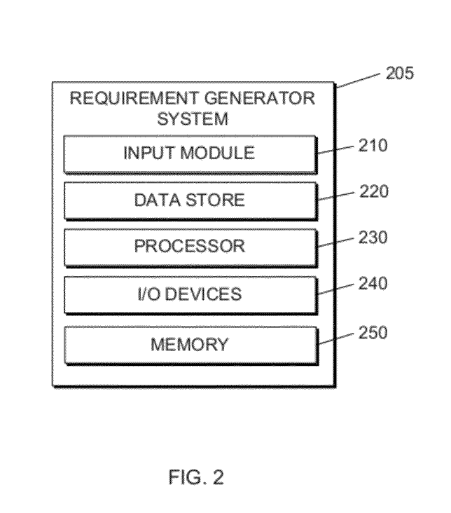

FIG. 2 illustrates an exemplary requirement generator system 205 for generating requirements of a project. The requirement generator system 205 includes an input module 210, a data store 220, one or more processors 230, one or more I/O (Input/Output) devices 240, and memory 250. The input module 220 may be used to input any type of information related to generating a requirement of a project on the requirement generator system 205. For example, the input module 210 may be used to receive a selection of industry and sub-industry information, one or more key performance indicators appropriate for the selected industry, one or more data structures appropriate for the selected industry, information defining a user-specific key performance indicator, or information defining a user-specific data structure. In some implementations, data from the input module 210 is stored in the data store 220. The data included in the data store 220 may include, for example, key performance indicator data defining one or more key performance indicators, mapping data defining formula and one or more data structures used in determining a measure of each key performance indicator, one or more data models, or one or more extract, transform, and load designs.

In some examples, the data store 220 may be a relational database that logically organizes data into a series of database tables. Each database table in the data store 220 may arrange data in a series of columns (where each column represents an attribute of the data stored in the database) and rows (where each row represents attribute values). In some implementations, the data store 220 may be an object-oriented database that logically or physically organizes data into a series of objects. Each object may be associated with a series of attribute values. In some examples, the data store 220 may be a type of database management system that is not necessarily a relational or object-oriented database. For example, a series of XML (Extensible Mark-up Language) files or documents may be used, where each XML file or document includes attributes and attribute values. Data included in the data store 220 may be identified by a unique identifier such that data related to a particular process may be retrieved from the data store 220.

The processor 230 may be a processor suitable for the execution of a computer program such as a general or special purpose microprocessor, and any one or more processors of any kind of digital computer. In some implementations, the requirement generator system 205 includes more than one processor 230. The processor 230 may receive instructions and data from the memory 250. The memory 250 may store instructions and data corresponding to any or all of the components of the requirement generator system 205. The memory 250 may include read-only memory, random-access memory, or both.

The one or more I/O devices 240 are configured to provide input to and output from the requirement generator system 205. For example, the one or more I/O devices 240 may include a mouse, a keyboard, a stylus, or any other device that allows the input of data. The one or more I/O devices 240 may also include a display, a printer, or any other device that outputs data.

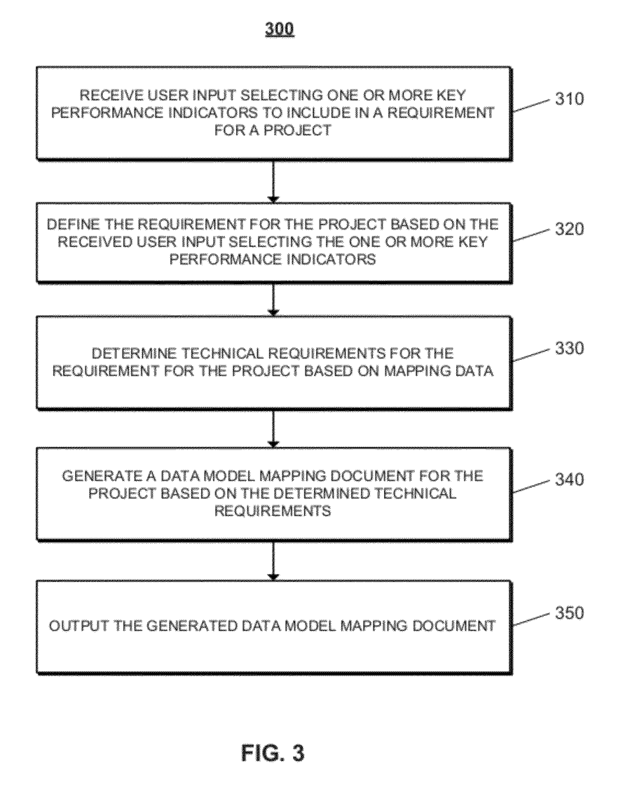

FIG. 3 illustrates a process 300 for generating requirements. The operations of the process 300 are described generally as being performed by the system 100. The operations of the process 300 may be performed by any one or more components of the system 100 or may be performed by the requirement generator system 205. In some implementations, operations of the process 300 may be performed by one or more processors included in one or more electronic devices.

The system 100 receives user input selecting one or more key performance indicators to include in a requirement for a project (310). The requirement may be, for example, a business requirement for a business intelligence project. The key performance indicators may be selected, for example, from key performance indicators that are predefined as being appropriate for a particular industry. For example, key performance indicators that are appropriate for a particular industry may include generic key performance indicators that are pre-defined as common key performance indicators for the particular industry. In this example, the system 100 may store common key performance indicators in association with one or more of several, different industries handled by the system 100. The system 100 may display the common key performance indicators for the appropriate industry to enable a user to review the common key performance indicators for the industry and select which of the common key performance indicators for the industry apply to the project.

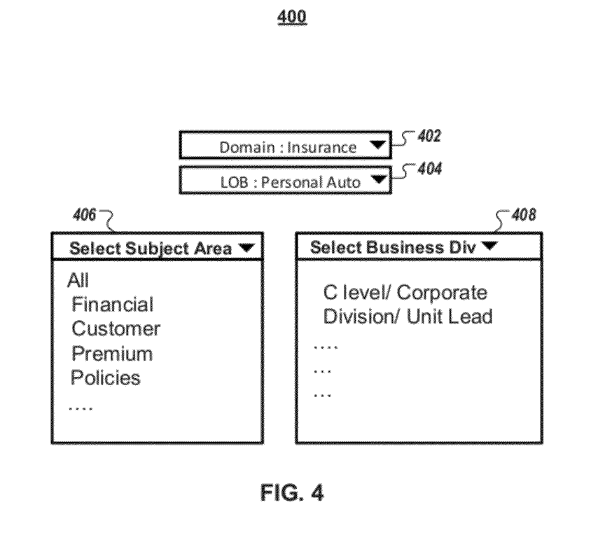

For example, the system 100 may receive user input selecting an industry associated with the project. FIG. 4 illustrates user interface components 400 for selecting a particular industry and selecting one or more subdivisions within the selected industry. For instance, the user may use a control 402 to select a particular industry. As shown, the user has selected the insurance industry. In some implementations, the user may use other controls to select a sub-industry or a particular aspect of the selected industry. For example, a control 404 may be used to select a line of business (e.g., personal automobiles) within the selected industry. As another example, the user may use a control 406 to select a subject area within the selected line of business. For instance, in the example of FIG. 4, the user may select all subject areas, or one or more of financial, customer, premium, or policies subject areas. As yet another example, the user may use a control 408 to select a business division associated with the selected line of business. For instance, a corporate division or a unit lead division may be selected. The user may use the user interface components 400 to broadly or specifically define an appropriate industry or scope of the project under development, so that the user is presented with common key performance indicators that are likely relevant to the project and that are likely helpful to the user in determining requirements for the project.

In this regard, after receiving a selection of a particular industry and associated sub-industry information, key performance indicators that are appropriate for the selected industry may be identified. Key performance indicators may be identified, for example, using mapping data which maps each industry and sub-industry combination to a set of one or more key performance indicators which are pre-defined as common key performance indicators for the industry and sub-industry combination. The identified key performance indicators may be presented to the user for selection to facilitate determination of the key performance indicators that are needed for the project.

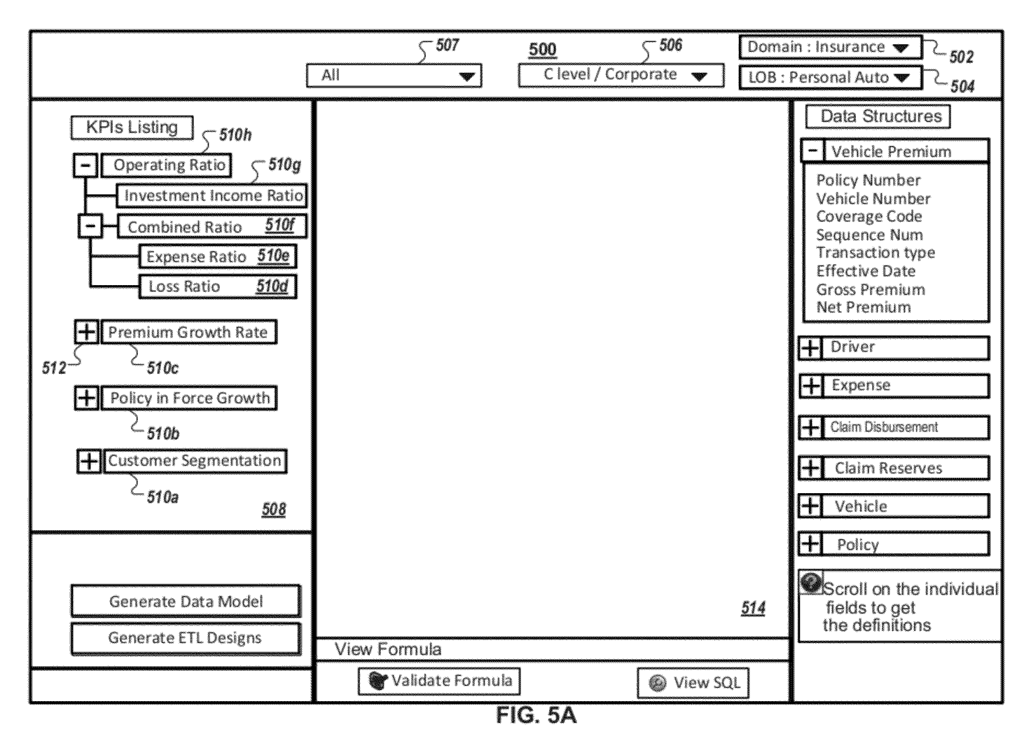

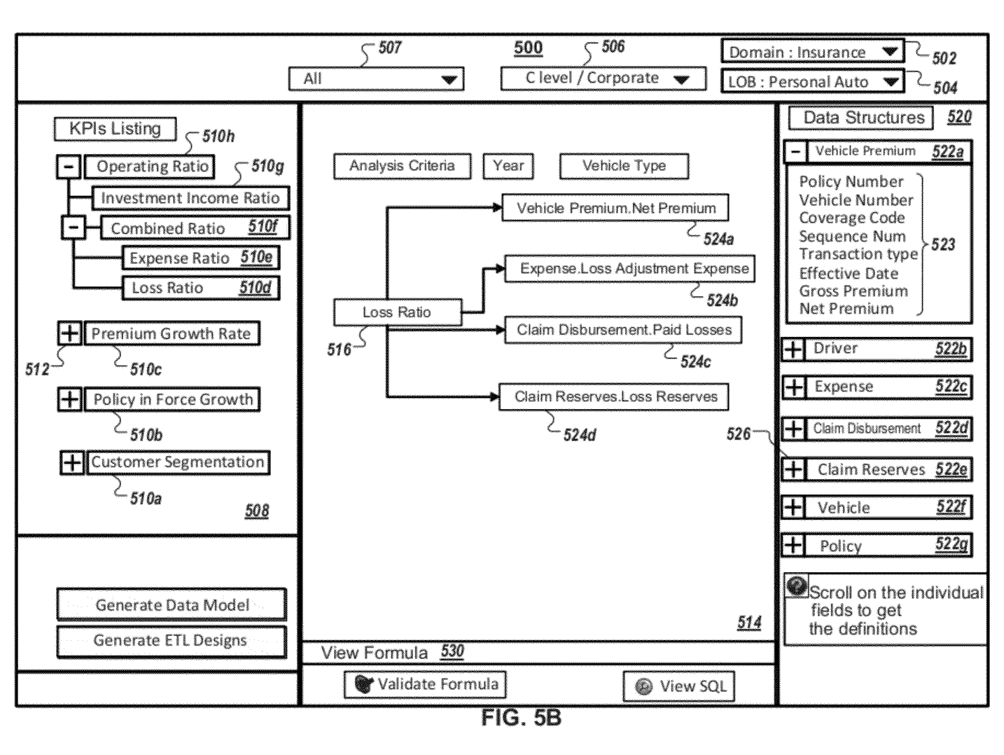

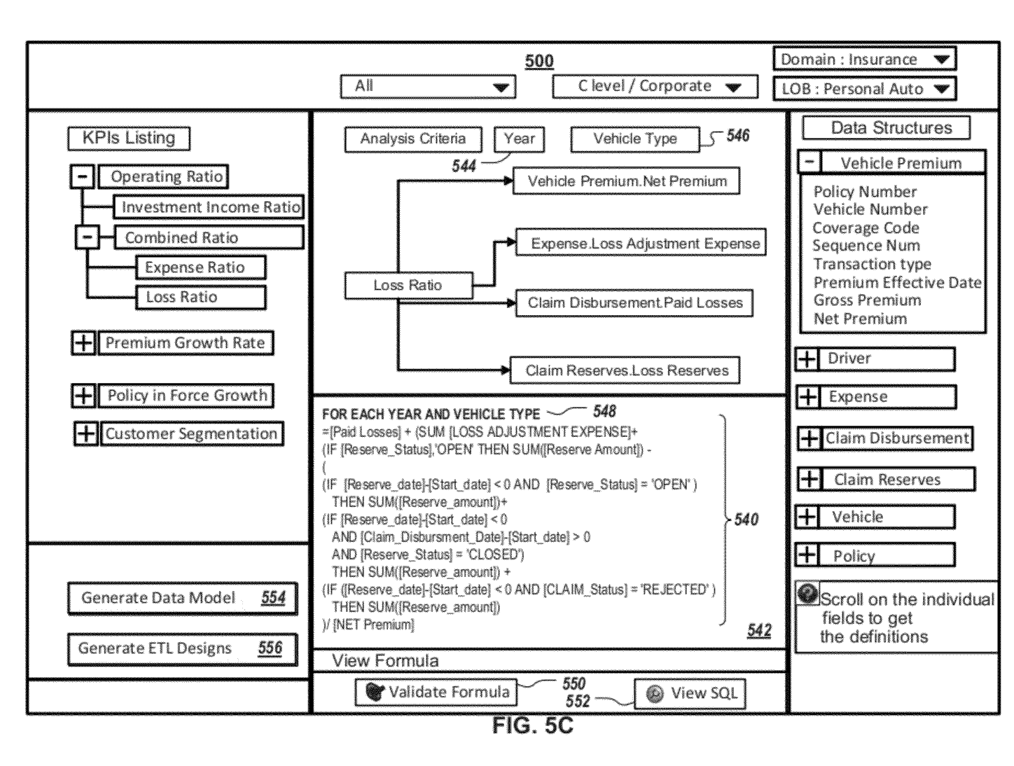

For example, FIG. 5 illustrates a user interface 500 which includes controls 502, 504, 506, and 507, which are similar to the controls 402, 404, 406, and 408 described above with respect to FIG. 4, in that the controls 502, 504, 506, and 507 allow a user to select an industry, a line of business, a division, and a subject area, respectively. In response to a selected industry 502 of insurance, a selected line of business 504 of personal automobile, and a selected division 506 of corporate, key performance indicators appropriate for the selections are displayed in an indicator area 508. For example, the indicator area 508 includes key performance indicators 510a, 510b, 510c, 510d, 510e, 510f, 510g, and 510h that are appropriate for the insurance industry, personal automobile line of business, and corporate division. The key performance indicators 510a, 510b, 510c, 510d, 510e, 510f, 510g, and 510h represent the key performance indicators of customer segmentation, policy in force growth, premium growth rate, loss ratio, expense ratio, combined ratio, investment income ratio, and operating ratio, respectively.

The key performance indicators displayed in the indicator area 508 may dynamically change based on changes in industry and sub-industry information made using the controls 502, 504, 506, and 507. For example, a user may wish to broaden, narrow, or otherwise change the scope of the project being designed and make changes to the scope of the project using the controls 502, 504, 506, and 507. The indicator area 508 is then updated based on the changes to the scope of the project made using the controls 502, 504, 506, and 507. In particular, the key performance indicators appropriate for the scope of the project currently selected may be displayed in the indicator area 508 for selection by the user. The dynamic changes may allow the user to easily select different industries and view the key performance indicators appropriate for the different industries to ensure that the user has reviewed the key performance indicators that are common and may be appropriate for the project.

Key performance indicators may be organized in and may be displayed in a hierarchy. For example, some key performance indicators may be “parent” key performance indicators and some key performance indicators may be “child” key performance indicators. A child key performance indicator may be, for example, derived from or may be a specialization of an associated parent key performance indicator. For example, the investment income ratio key performance indicator 510g is shown as a specialization of the operating ratio key performance indicator 510h, and the expense ratio key performance indicator 510e and the loss ratio key performance indicator 510d are each shown as specializations of the combined ratio key performance indicator 510f.

Parent key performance indicators may, when displayed in the indicator area 508, include a control, such as the control 512, which allows the user to view or hide related child key performance indicators. In some implementations, a key performance indicator may be both a parent key performance indicator and a child key performance indicator. In some implementations, only the leaf key performance indicators displayed in the indicator area 508 (e.g., key performance indicators without children, such as the loss ratio 510d, the expense ratio 510e, and the investment income ratio 510f indicators) are actually key performance indicators and the non-leaf (e.g., parent) key performance indicators are rather category labels used to organize the leaf key performance indicators.

The user may select one or more key performance indicators 510. For example, the user may select one or more key performance indicators 510 and may “drag” and “drop” the selected key performance indicators 510 onto a project definition area 514, to include the dropped key performance indicator in the requirement for the project. For example and as shown in FIG. 5B, the loss ratio key performance indicator 510d has been dropped onto the project definition area 514, as indicated by an associated key performance indicator 516.

In some implementations, the user can specify or can define a user-specific key performance indicator that is different from the key performance indicators displayed in response to a change in the controls 502, 504, 506, and 508. For example, the user can define a key performance indicator that is specific to a particular project if the known key performance indicators are not sufficient to define the requirement. When defining the user-specific key performance indicator, the user may adapt an existing key performance indicator or define the user-specific key performance indicator from scratch. In some implementations, a user-specified key performance indicator may be added to the set of key performance indicators that are appropriate for the selected industry, to make the user-specified key performance indicator available for use in future projects.

Returning to FIG. 3, the system 100 defines the requirement for the project based on the received user input selecting the one or more key performance indicators (320). For example, one or more data structures to include in the requirement may be identified, where a data structure stores data needed in determining a measure for one or more key performance indicators. Data structures may be identified, for example, based on mapping data.

In some implementations, some or all data structures to include in the requirement may be identified automatically by the system, based on the selected key performance indicators. For example, data structures may be identified using a source to target mapping table. In this example, the source to target mapping table may list, for each key performance indicator, a set of data structures used in determining a measure for the key performance indicator. As another example, some or all data structures used for the requirement may be selected by the user from a set of available data structures.

As shown in FIG. 5B, based on the industry and sub-industry selections in the controls 502, 504, 506, and 507, data structures that are appropriate for the selected industry and sub-industries may be identified and may be displayed in a data structures area 520. For example, the data structures area 520 includes vehicle premium 522a, driver 522b, expense 522c, claim disbursement 522d, claim reserves 522e, vehicle 522f, and policy 522g data structures.

In some implementations, a data structure may include, for example, one or more other data structures. In addition, some data structures may include one or more fields. For instance, the vehicle premium data structure 522a includes eight fields 523, including the fields of policy number, vehicle number, coverage code, sequence number, transaction type, effective date, gross premium, and net premium. For data structures that include fields or other data structures, a control, such as the control 526, may be configured to, in response to selection, either show or hide the items included in a particular data structure.

A user may select one or more data structures 522 from the data structures area 520 and may drop the selected data structures 522 onto the project definition area 514, to include the selected data structures 522 in the requirement for the project. In some implementations, the user may select an entire data structure 522 and/or may select a particular field of a data structure 522. For example, a net premium field 524a has been dropped onto the project definition area 514 after being dragged from the vehicle premium data structure 522a. As other examples, a loss adjustment expense field 524b has been dropped onto the project definition area 514 after being dragged from the expense data structure 522c, a paid losses field 524c has been dropped onto the project definition area 514 after being dragged from the claim disbursement data structure 522d, and a loss reserves field 524d has been dropped onto the project definition area 514 after being dragged from the claim reserves data structure 522e.

In implementations where at least some of the data structures are identified automatically by the system, the identified data structures may be automatically placed onto the project definition area 514 in response to a key performance indicator being added to the project definition area 514. For example, in response to the user dropping the loss ratio key performance indicator 516 onto the project definition area 514, some or all of the fields 524a, 524b, 524c, and 524d may be automatically identified as being needed to determine a measure for the loss ratio key performance indicator 516. In response to the identification of some or all of the fields 524a, 524b, 524c, and 524d, some or all of the fields 524a, 524b, 524c, and 524d are placed onto the project definition area 514 and associated with the loss ratio key performance indicator 516 (e.g., as shown, arrow lines may connect a key performance indicator to related fields or data structures). In some implementations, the user may specify or define a user-specific data structure that is different than the known data structures that are displayed in response to a change in the controls 502, 504, 506, and 507.

The requirement for the project is defined based on the selected key performance indicators and on the selected and/or automatically identified data structures. The selected key performance indicators used to define the requirement may include one or more key performance indicators that the user has selected from predefined key performance indicators identified as appropriate for the selected industry and/or one or more user-specified key performance indicators. Similarly, the selected data structures used to define the requirement may include one or more data structures that the user has selected from predefined data structures identified as appropriate for the selected industry, one or more data structures automatically selected as being associated with one or more selected key performance indicators, and/or one or more user-specified data structures.

Returning to FIG. 3, the system 100 determines technical requirements for the requirement for the project based on mapping data (330). The mapping data may include, in addition to definitions of data structures, a formula definition for each selected key performance indicator, where the formula is used in determining a measure of the key performance indicator. Defining technical requirements may include, for example, generating code for each of the selected key performance indicators using the formula definition and the selected data structures.

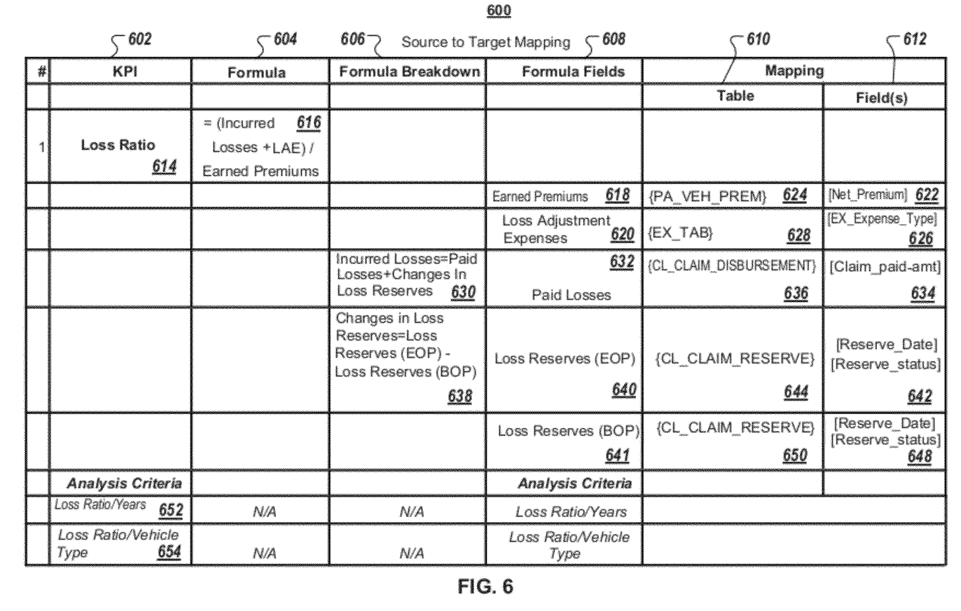

As shown in FIG. 5B, the user may select a control 530 to view the formula for a selected key performance indicator. For example and as shown in FIG. 5C, a formula 540 is displayed in a formula area 542 in response to selection of the control 530. The formula 540, and other technical requirements, may be determined using a source to target mapping table. For example, FIG. 6 illustrates a source to target mapping table 600. The source to target mapping table 600 includes a key performance indicator column 602, a formula column 604, a formula breakdown column 606, a formula fields column 608, a table mapping column 610, and a fields mapping column 612.

The key performance indicator column 602 includes an identifier of one or more key performance indicators. For example, the key performance indicator column 602 includes an identifier for a loss ratio key performance indicator 614. The formula column 604 includes, for each key performance indicator, a formula defining how a measure of the key performance indicator is determined. For example, the formula column 604 includes a formula 616 for the loss ratio key performance indicator 614, defined as the sum of incurred losses and loss adjustment expenses (LAE) divided by earned premiums.

The formula fields column 608 includes formula fields which are included in a formula defined in the formula column 604 that can be mapped to a field in a database table. For example, the fields column 608 includes an earned premiums formula field 618 and a loss adjustment expenses formula field 620 that are included in the formula 616. The table mapping column 610 and the fields mapping column 612 include, for each formula field, an indicator of a database table and one or more fields included in the database table, respectively, that may be used to store data associated with the formula field. For example, a “[Net_Premium]” database field 622 included in a “{PA_VEH_PREM}” database table 624 may be used to store data for the earned premiums formula field 618. As another example, an “[EX_Expense_Type]” database field 626 included in a “{EX_TAB}” database table 628 may be used to store data for the loss adjustment expenses formula field 620.

The formula breakdown column 606 may include definitions for intermediate formulas, where an intermediate formula defines how to derive a composite field, with a composite field being a formula field that is not mapped directly to a database field. For example, the formula breakdown column 606 includes an intermediate formula 630 defining an incurred losses composite formula field that is included in the formula 616 to be “paid losses” +“changes in loss reserves”. The formula fields column 608 may include formula fields which are included in an intermediate formula defined in the formula breakdown column 606. For example, the fields column 608 includes a paid losses formula field 632 that is included in the intermediate formula 630. A “[Claim_paid-amt]” database field 634 included in a “{CL_CLAIM_DISBURSEMENT}” database table 636 may be used to store data for the paid losses formula field 632 that is included in the intermediate formula 630.

An intermediate formula included in the formula breakdown column 606 may refer to one or more other composite formula fields. For example, the intermediate formula 630 refers to a composite field “changes in loss reserves”. Composite formula fields that are included in an intermediate formula may be defined by another, nested intermediate formula that is included in the formula breakdown column 606. For example, a nested intermediate formula 638 defines the “changes in loss reserves” composite formula field to be “loss reserves at end of period (EOP)” minus “loss reserves at beginning of period (BOP)”.

The formula fields column 608 may include formula fields which are included in a nested intermediate formula defined in the formula breakdown column 606. For example, the formula fields column 608 includes a “loss reserves EOP” formula field 640 and a “loss reserves BOP” formula field 641 that are included in the nested intermediate formula 638. Two database fields, namely “[Reserve_Date]” and “[Reserve_Status]” database fields 642 included in a “{CL_CLAIM_RESERVE}” database table 644, may be used to store data for the “loss reserves EOP” formula field 640. Similarly, “[Reserve_Date]” and “[Reserve_Status]” database fields 648 included in a “{CL_CLAIM_RESERVE}” database table 650 may be used to store data for the “loss reserves BOP” formula field 641.

Returning to FIG. 5C, in some implementations, the user may specify analysis criteria which may result in the iteration of execution of code for the formula 540 over one or more data sets. For example, the user may specify to iterate the execution of code for the formula 540 over year 544 and vehicle type 546 data sets, as indicated by an iteration statement 548 included in the formula 540. Analysis criteria may be included in the source to target mapping table. For example and as shown in FIG. 6, the source to target mapping table 600 includes information for a loss ratio key performance indicator defined in terms of years 652 and a loss ratio key performance indicator defined in terms of vehicle type 654.

In some implementations, the user may provide input to change the code generated for the formula 540. For example, the user may be able to edit the formula 540 directly in the formula area 542, or may be able to launch a separate code editor to edit the code of the formula 540. The user may be able to validate the formula 540 by selecting a control 550. For example, in response to selecting the control 550, the code for the formula 540 may be verified to ensure that the syntax of the formula 540 is correct. As another example, the code for the formula 540 may be evaluated or otherwise executed using a set of test data on a system on which the project is to be implemented. In this example, the code for the formula 540 is tested on the system on which the project is to be implemented and results of the test are output to the user to confirm whether or not the code for the formula 540 is working properly on the system.

In some implementations, the user may select a control 552 to view SQL (Structured Query Language) or other-language code associated with the formula 540. For example, the SQL code may be used to retrieve data from one or more databases for one or more data structures referenced in the formula 540 when evaluating the formula 540. As another example, in some implementations, the code for the formula 540 is non-executable, generic template code, and the SQL or other-language code is a specific implementation of the generic template code (e.g., the SQL code may be code that is executable on a particular target system).

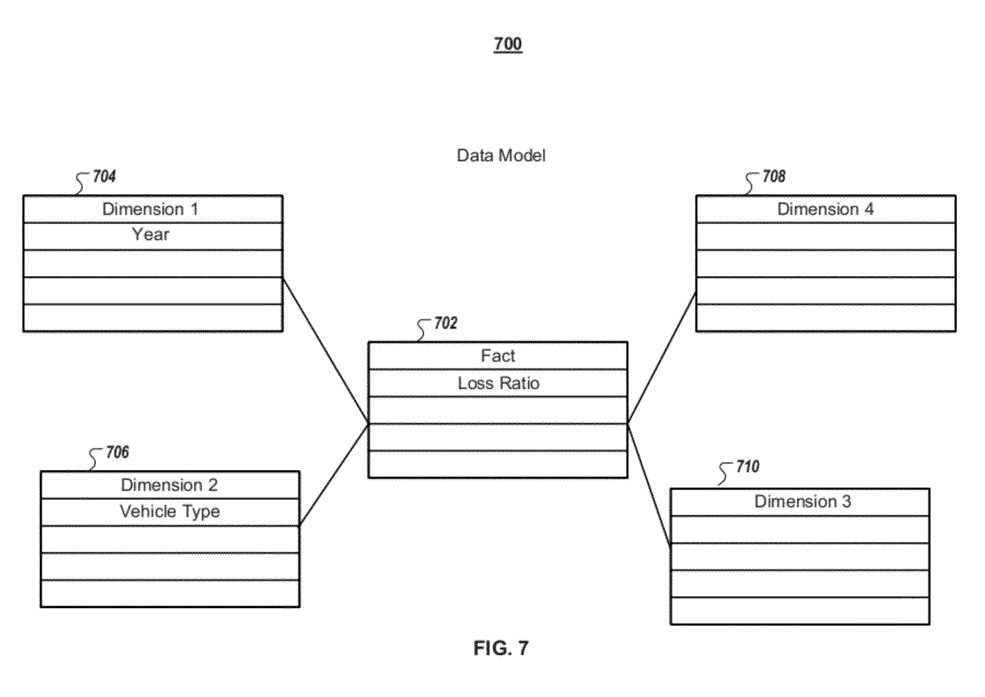

Returning to FIG. 3, the system 100 generates one or more data model mapping documents for the project based on the determined technical requirements (340). A data model mapping document may be, for example, a data model, an extract, transform, and load design, a spreadsheet, or some other type of document. For example, FIG. 7 illustrates a data model 700 that may be used, for example, in data warehousing processes. The data model 700 may be generated automatically, such as in combination with code generation, or the data model 700 may be generated in response to a user input (e.g., selection of a control 554 illustrated in FIG. 5C). The data model 700 may be generated automatically based on the data structures needed to compute measures for the key performance indicators selected during definition of the project.

The data model 700 may include one or more fact tables. A fact table may indicate one or more measures by which a business process may be analyzed, and thus may be related to one or more key performance indicators. For example, a fact table 702 is related to a loss ratio key performance indicator. A fact table may be related to one or more dimension elements. For example, the fact table 702 is related to dimension elements 704, 706, 708, and 710. A dimension element is an element by which a fact table may be analyzed or filtered. For example, the fact table 702 for the loss ratio key performance indicator may be analyzed or filtered by year (e.g., dimension element 704), by vehicle type (e.g., dimension element 706), or by various other dimensions that are related to the fact table 702. The data model 700 may automatically include a fact table and corresponding dimensions for each of the key performance indicators selected as a requirement for the project.

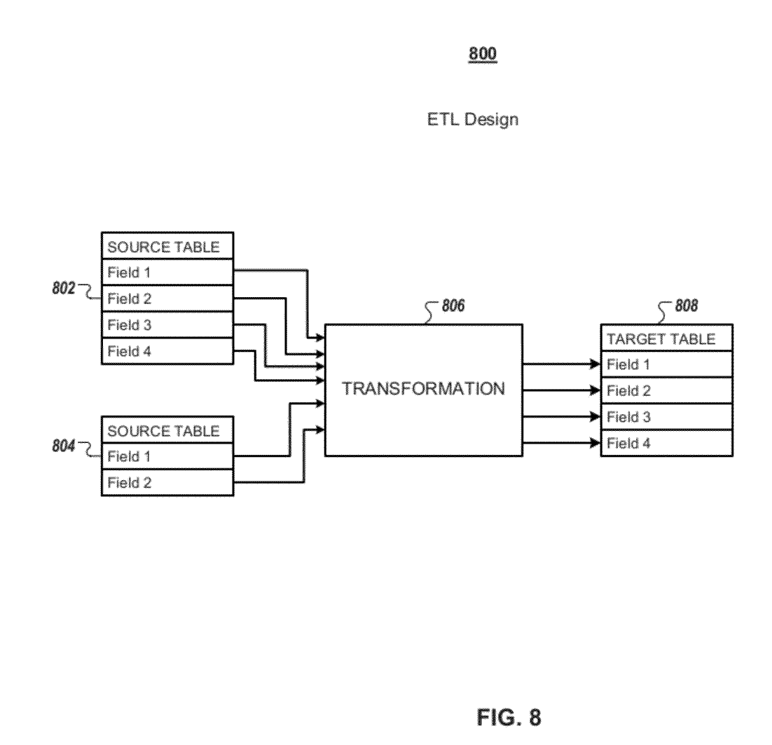

FIG. 8 illustrates an example extract, transform, and load design 800. The extract, transform, and load design 800 includes one or more designs for extracting data from one or more source tables (e.g., source tables 802 and 804), transforming the extracted data using zero or more transformations (e.g., transformation 806), and loading the transformed data (or, if there are no transformations, the extracted data) into one or more target tables (e.g., target table 808). For instance, in the example shown in FIG. 8, four fields are extracted from the source table 802 and two fields are extracted from the source table 804. The transformation 806 transforms the extracted fields and loads transformed data into four fields of the target table 808. The transformation 806 may, for example, merge one or more source table fields or otherwise aggregate data, may create a derived value from one or more source table fields using one or more operations, may sort data, may encode data, may map source table field values into corresponding target field values, or may perform a number of other transformation operations.

The extract, transform, and load design 800 may document an extract, transform, and load process for retrieving data from one or more source tables to enable loading of the data into one or more target tables. The data may be loaded for purposes of measuring one or more key performance indicators by executing code for one or more formulas on a target system. The extract, transform, and load design 800 may be generated automatically, such as in combination with code generation, or the extract, transform, and load design 800 may be generated in response to a user input (e.g., selection of a control 556 illustrated in FIG. 5C). The extract, transform, and load design 800 may be automatically determined by identifying data needed to determine a measure for one or more key performance indicators included in the requirement for the project and identifying source tables and any transformations needed to arrive at the data needed to determine the measure for the one or more key performance indicators. The extract, transform, and load design 800 then may be updated to include the identified source tables and any transformations needed to be performed on the data stored in the source tables to arrive at the data needed to determine the measure for the one or more key performance indicators. The identified source tables and transformations may be mapped to one or more target tables that are designed to store the data needed to determine the measure for the one or more key performance indicators.

Returning to FIG. 3, the system 100 outputs the generated data model mapping document (350). For example, a data model or an extract, transform, and load design may be printed, saved to electronic storage, sent to one or more electronic recipients, displayed on a display device, or outputted in some other manner.

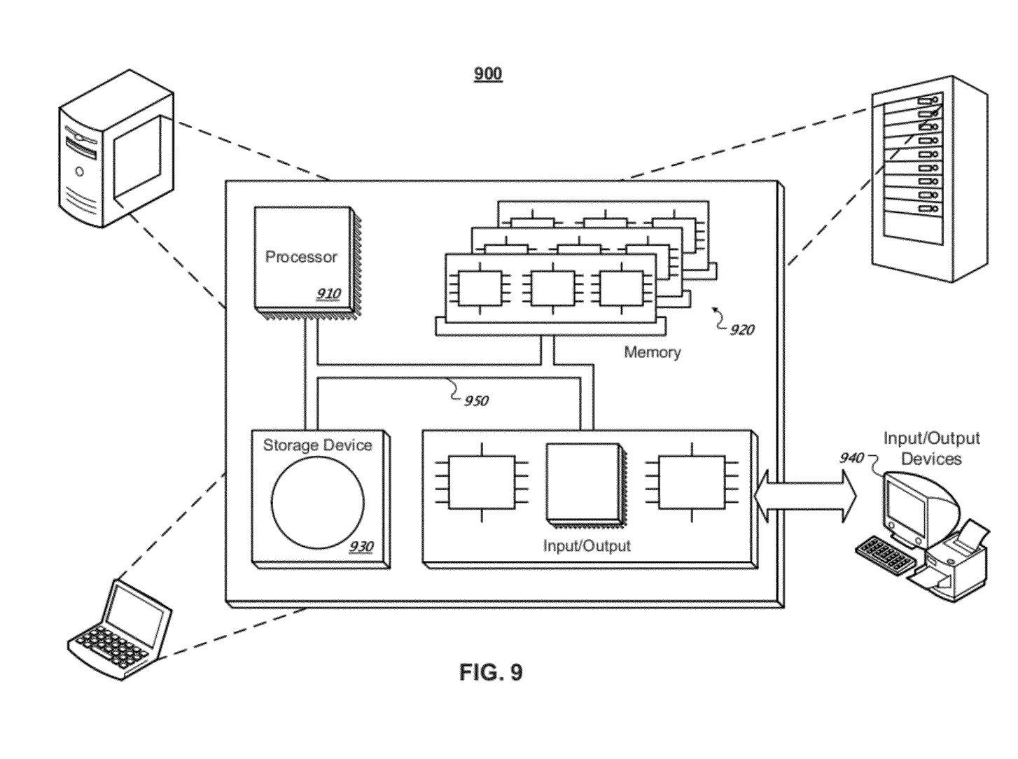

FIG. 9 is a schematic diagram of an example of a generic computer system 900. The system 900 can be used for the operations described in association with the process 300, according to one implementation. For example, the system 900 may be included in the client device 102, and the systems 104 and 205.

The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940 and perform data processing operations.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A computer system comprising:
at least one processor; and
at least one memory coupled to the at least one processor having stored thereon:
key performance indicator data defining key performance indicators available for selection in defining a requirement for a project;
mapping data defining formula and one or more data structures used in determining a measure of each key performance indicator included in the key performance indicator data; and
instructions which, when executed by the at least one processor, cause the at least one processor to perform operations comprising:
receiving user input selecting, from among the key performance indicators defined by the key performance indicator data, one or more key performance indicators to include in a requirement for a project;
defining the requirement for the project based on the received user input selecting the one or more key performance indicators;
determining technical requirements for the requirement for the project based on the mapping data defining formula and one or more data structures used in determining a measure of the one or more selected key performance indicators;
generating a data model mapping document for the project based on the determined technical requirements; and
outputting the generated data model mapping document.

2. The system of claim 1:
wherein the key performance indicator data defines key performance indicators available for selection in defining a business requirement for a business intelligence project;
wherein receiving user input selecting one or more key performance indicators to include in the requirement for the project comprises receiving user input selecting one or more key performance indicators to include in a business requirement for a business intelligence project;
wherein defining the requirement for the project based on the received user input selecting the one or more key performance indicators comprises defining the business requirement for the business intelligence project based on the received user input selecting the one or more key performance indicators;
wherein determining technical requirements for the requirement for the project based on the mapping data defining formula and one or more data structures used in determining a measure of the one or more selected key performance indicators comprises determining technical requirements for the business requirement for the business intelligence project based on the mapping data defining formula and one or more data structures used in determining a measure of the one or more selected key performance indicators; and
wherein generating the data model mapping document for the project based on the determined technical requirements comprises generating a data model mapping document for the business intelligence project based on the determined technical requirements.

3. The system of claim 1, wherein receiving user input selecting, from among the key performance indicators defined by the key performance indicator data, one or more key performance indicators to include in the requirement for the project comprises:
receiving user input selecting an industry associated with the project;
identifying, from among the key performance indicators defined by the key performance indicator data, key performance indicators that are appropriate for the selected industry;
presenting, for selection, the identified key performance indicators that are appropriate for the selected industry; and
receiving user input selecting, from among the identified key performance indicators that are appropriate for the selected industry, one or more key performance indicators to include in the requirement for the project.

4. The system of claim 3, wherein the identified key performance indicators that are appropriate for the selected industry comprise generic key performance indicators that are pre-defined as common key performance indicators for the selected industry.

5. The system of claim 1, wherein the operations further comprise:
receiving user input selecting an industry associated with the project;
identifying, from among the data structures included in the mapping data, data structures that are appropriate for the selected industry;
presenting, for selection, the identified data structures that are appropriate for the selected industry; and
receiving user input selecting, from among the identified data structures that are appropriate for the selected industry, one or more data structures to include in the requirement for the project.

6. The system of claim 5, wherein the identified data structures that are appropriate for the selected industry comprise generic data structures that are pre-defined as common data structures for the selected industry.

7. The system of claim 1, wherein the identified data structures that are appropriate for the selected industry comprise system-specific data structures that are data structures for the selected industry included in a system on which the project is to be implemented.

8. The system of claim 1, wherein receiving user input selecting, from among the key performance indicators defined by the key performance indicator data, one or more key performance indicators to include in the requirement for the project comprises:
receiving user input selecting an industry associated with the project;
identifying, from among the key performance indicators defined by the key performance indicator data, key performance indicators that are appropriate for the selected industry;
identifying, from among the data structures included in the mapping data, data structures that are appropriate for the selected industry;
presenting, for selection, the identified key performance indicators that are appropriate for the selected industry;
presenting, for selection, the identified data structures that are appropriate for the selected industry;
receiving user input selecting, from among the identified key performance indicators that are appropriate for the selected industry, one or more key performance indicators to include in the requirement for the project; and
receiving user input selecting, from among the identified data structures that are appropriate for the selected industry, one or more data structures to include in the requirement for the project.

9. The system of claim 1, wherein defining the requirement for the project based on the received user input selecting the one or more key performance indicators further comprises:
receiving user input defining a user-specific key performance indicator that is different from the key performance indicators defined by the key performance indicator data; and
defining the requirement for the project based on the received user input selecting the one or more key performance indicators and the received user input defining the user-specific key performance indicator.

10. The system of claim 1, wherein the operations further comprise:
generating a reporting template for the project based on the requirement for the project and the determined technical requirements; and
outputting the generated reporting template.

11. The system of claim 1, wherein determining technical requirements for the requirement for the project based on the mapping data defining formula and one or more data structures used in determining a measure of the one or more selected key performance indicators comprises generating code for determining a measure of each of the one or more selected key performance indicators using the mapping data that pre-defines the formula and the one or more data structures used in determining the measure of each of the one or more selected key performance indicators.

12. The system of claim 11, wherein the operations further comprise enabling a user to provide input to change the generated code for determining the measure of each of the one or more selected key performance indicators.

13. The system of claim 11, wherein the operations further comprise validating the generated code for determining the measure of each of the one or more selected key performance indicators.

14. The system of claim 13, wherein validating the generated code for determining the measure of each of the one or more selected key performance indicators comprises testing the generated code for determining the measure of each of the one or more selected key performance indicators on a system on which the project is to be implemented.

15. The system of claim 1:
wherein receiving user input selecting, from among the key performance indicators defined by the key performance indicator data, one or more key performance indicators to include in a requirement for a project comprises:
displaying, in a graphical user interface, a list of key performance indicators available for inclusion in a requirement for a project; and
receiving user input dragging, from the list of key performance indicators available for inclusion in the requirement for the project, a key performance indicator into a project definition area of the graphical user interface; and
wherein defining the requirement for the project based on the received user input selecting the one or more key performance indicators comprises:
identifying, based on the mapping data, one or more data structures that store data needed in determining a measure for the key performance indicator dragged into the project definition area of the graphical user interface;
displaying, in the project definition area of the graphical user interface, the identified one or more data structures in connection with the key performance indicator; and
defining the requirement for the project based on the key performance indicator and the identified one or more data structures.

16. The system of claim 1:
wherein the mapping data comprises a source to target mapping table; and
wherein determining technical requirements for the requirement for the project based on the mapping data defining formula and one or more data structures used in determining a measure of the one or more selected key performance indicators comprises determining technical requirements for the requirement for the project based on the source to target mapping table.

17. The system of claim 1:
wherein generating the data model mapping document for the project based on the determined technical requirements comprises generating a data model for the project based on the determined technical requirements; and
wherein outputting the generated data model mapping document comprises outputting the generated data model.

18. The system of claim 1:
wherein generating the data model mapping document for the project based on the determined technical requirements comprises generating an extract, transform, and load design for the project based on the determined technical requirements; and
wherein outputting the generated data model mapping document comprises outputting the generated extract, transform, and load design.

19. A method comprising:
receiving user input selecting, from among key performance indicators stored in key performance indicator data defining key performance indicators available for selection in defining a requirement for a project, one or more key performance indicators to include in a requirement for a project;
defining the requirement for the project based on the received user input selecting the one or more key performance indicators;
determining technical requirements for the requirement for the project based on mapping data defining formula and one or more data structures used in determining a measure of the one or more selected key performance indicators;
generating a data model mapping document for the project based on the determined technical requirements; and
outputting the generated data model mapping document.

20. At least one computer-readable storage medium encoded with executable instructions that, when executed by at least one processor, cause the at least one processor to perform operations comprising:
receiving user input selecting, from among key performance indicators stored in key performance indicator data defining key performance indicators available for selection in defining a requirement for a project, one or more key performance indicators to include in a requirement for a project;
defining the requirement for the project based on the received user input selecting the one or more key performance indicators;
determining technical requirements for the requirement for the project based on mapping data defining formula and one or more data structures used in determining a measure of the one or more selected key performance indicators;
generating a data model mapping document for the project based on the determined technical requirements; and
outputting the generated data model mapping document.
